(19) United States
(12) Patent Application Publication
(10) Pub. No.: US 2018/0013281 A1
(43) Pub. Date: Jan. 11, 2018

(54) LEAKAGE CURRENT INTERRUPTION DEVICE FOR ELECTRICAL LOAD

(71) Applicant: SUNGHYUN E&C.,LTD.,, Gyeonggi-do (KR)

(72) Inventors: Kwang Youn PARK, Seoul (KR); Sangheon LEE, Gyeonggi-do (KR); Jae Heung PARK, Incheon (KR); Jung Ryul KIM, Seoul (KR)

(21) Appl. No.: 15/545,273

(22) PCT Filed: Jan. 19, 2016
(86) PCT No.: PCT/KR2016/000559

§ 371 Date: Jul. 20, 2017

(30) Foreign Application Priority Data
Jan. 20, 2015 (KR) 10-2015-0009014

(51) Int. Cl. H02H 3/16; H02H 1/00

(52) U.S. Cl. CPC H02H 3/162; H02H 1/0007

(57) ABSTRACT

A leakage current interruption device comprises: the leakage current interruption device in which it is coupled electrically between the power switch and the load: the first and second input stages coupled with a side of the power source; the first and second output stages coupled with a side of the load; the first and second switching members for turning on and off respectively the electrical connection between the first and second input stages and the first and second output stages; a switching driving member in which it is coupled between the first and second input stages and generates and outputs a switching driving signal to turn on or off the first and second switching members according to the on or off signals of the power switch.

### BACKGROUND

The present invention relates to a leakage current interruption device for electrical load which interrupts the leakage current flowing through an electrical load, and more specifically, to a leakage current interruption device in which in the construction such as a house or a building and so on, at a state that a power switch is set as the open state, the whole leakage current capable of flowing through the electrical load can be interrupted completely.

The electric load is called the whole instruments or devices being driven by using electrical energy: it includes home appliances, a lamp, industrial devices being driven by using electrical energy, and a driving device such as a motor.

These electrical loads are driven by using electrical energy supplied from the outside, and necessarily have a power switch for interrupting electricity supplied from the outside.

In order to turn on and off the driving of electrical load, the electricity being supplied to the load is interrupted and therefore the installation position of the power switch is not limited at a specific place. Accordingly, most of loads of power switches are installed at a position that a user or a manager can easily control the load. For example, in case of most of home appliances, the power switch is equipped with a body of the home appliance and in case of a load such as a lamp which is installed at a position that is located away more than a constant distance from a user, a switch is equipped with the middle portion of a line for supplying the electrical energy to the load. Also, there exist many cases: in case that the power switch is equipped with the body like home appliances or industrial devices and so on, a power switch is equipped with the middle portion of the electrical line and then the corresponding load is turned on or off by using it.

On the other hand, when using the electrical load, in case that the power switch is set as an off state, current flows often through the load, and this is called in general as a leakage current. The leakage current causes not only the loss of the electrical energy and but also the electrical accident such as fire or electrical shock and so on and so it is necessary to be managed it well.

FIG. 1 is a conceptual diagram for explaining the leakage current which can be generated when using the electrical load. At present, in Republic of Korea, 220V/380V are used as nominal voltages, and as a power distribution system, the Y connection system(three-phase four-wire system) and the delta connection system(three-phase three-wire system) which are called as the multi-grounded wye system are used. Here, in the Y connection system, 220V/380V (phase voltage/line-to-line voltage) are supplied through the line L (Live conductor) or R, S, and T phases and the line N (Neutral conductor) or N phase, and in case of the delta connection system, without distinction of phase voltage and line-to-line voltage, 220V is supplied through the line L (Live conductor) or R,S, and T phases.

FIG. 1 shows a wiring system supplying power to loads such as lamps by using the lines L and N as a type of the power distribution system.

As shown in FIG. 1, loads are coupled with AC(Alternating Current) power source through power switches SW1 and SW2. Here, the load 10 includes a plurality of loads 10-1˜10-n, and the load 20 includes a plurality of loads 20-1˜20-n. Here, everything being driven by AC power source is included as the loads 10 and 20. Also, although all loads are connected in parallel in FIG. 1, the plurality of loads 10-1˜10-n and 20-1˜20-n are connected in parallel or series to AC power source.

As shown in FIG. 1, the load 10 is turned on/off by the power switch SW1 installed at the line L or R,S, and T phases, the load 20 is turned on/off by the power switch SW2 installed at the line N or N phase. In the normal driving state, when the power switches SW1 and SW2 are turned on, current flows alternately from the line L to the line N and from the line N to the line L, thereby being supplied electrical energy to the loads 10 and 20. When the power switches SW1 and SW2 are turned off, the flow of current is cut off, thereby being cut off the supply of electrical energy.

Meanwhile, in many cases, an improper virtual ground existed at the power line which is continued from the line L to the line N through loads 10 and 20. This generally occurred by deterioration of loads 10 and 20 or lines such as damage of most lines or permeation of moisture and so on, however, also by the construction which is necessarily required to loads 10 and 20 such as a radiation member existing as loads 10 and 20. For example, in case of an high-brightness LED which has widely used lately as a lamp, a radiation plate is used for radiation. This radiation plate is attached to the material with high heat conduction property such as metal and so on and then used. And, since the material with high heat conduction property has also high conductivity, if dust or moisture and so on is permeated into a device, it is activated improperly as a virtual ground. And, this virtual ground acts as a direct cause of leakage current.

Like the load 10, when the power switch SW1 is installed to the line L, although there exists a virtual ground on the load 10 or the line, the power switch SW1 is turned off and simultaneously the flow of the current to the line or the load 10 is cut off, so that a serious problem by the virtual ground does not occurred.

However, when the power switch SW2 is installed to the line N like the load 20, although the power switch SW2 is turned off, the flow of current between the line L and the virtual ground is formed and the leak current flows, so that there occurs a problem that the electrical energy is supplied to the load. This leakage current not only consumes the electrical energy unnecessarily and but also acts as a cause of fire or an electrical shock and so on. Especially, in case that the load 20 flowing the leakage current is an illumination device such as a lamp, although the power switch SW2 is turned off, a weak current flows to an illumination lamp and so the weak illumination light is radiated from the illumination lamp or flicker phenomenon in which the illumination lamp is intermittently turned on or off occurred.

In order to solve the above problem, it is required to install necessarily the power switch to the line L. However, since it is required to confirm the line L at every works, there occurs a problem that the work efficiency is lowered largely. Also, if this confirmation work is performed improperly, as described above, there are problems that fire or the risk of electric shock due to the leakage current, and the unnecessary electric energy consumption and so on occurred.

On the other hand, unlike the electric distribution type of FIG. 1 by using the line L and the line N, in the electric distribution type for supplying the electric energy to the loads by using the line L, that is, R, S, and T phases, there is the more serious problem: although the power switch is installed to any parts of the line connected with the loads, there is a problem that the leakage current can always occurred at the off state of the power switch.

### SUMMARY OF THE INVENTION

In consideration of the above-described problems of the prior art, it is an object of the present invention to provide to a leakage current interruption device in which at a state that a power switch is set as the off state, the flowing of the leakage current through the load is prevented by cutting off originally the whole current being supplied to the load.

In order to accomplish the above objects, according to an aspect of the present invention, there is provided a leakage current interruption device in which it is installed at the power line for supplying the electrical energy to the electrical load and it is cut off the leakage current flowing to the load comprising:

the leakage current interruption device in which it is coupled electrically between the power switch and the load:

first and second input stages coupled with a side of the power source;

first and second output stages coupled with a side of the load;

first and second switching members for turning on and off respectively the electrical connection between the first and second input stages and the first and second output stages;

a switching driving member in which it is coupled between the first and second input stages and generates and outputs a switching driving signal to turn on or off the first and second switching members according to the on or off signals of the power switch.

The leakage current interruption device according to the present invention having the above-described configuration has effects as follows. When the power switch is set as the off state, the off state is detected and then the load is cut off completely from the power line, thereby preventing the leakage current and so on from flowing through the load. Accordingly, fire or the risk of electrical shock generated from the improper current flow such as the leakage current and so on, the unnecessary electric energy consumption, and the flicker phenomenon in the illumination lamp and so on can be removed.

### BRIEF DESCRIPTION OF THE DRAWINGS

FIG. 1 is a conceptual view illustrating a leakage current which can be generated when using an electric load.

FIG. 2 is a block construction view illustrating the construction of a leakage current interruption device according to an embodiment of the present invention.

FIG. 3 is a circuit construction view illustrating an embodiment of real construction of the leakage current interruption device of FIG. 2.

FIG. 4 is a circuit construction view illustrating another embodiment of the leakage current interruption device of FIG. 2.

### DETAILED DESCRIPTION OF THE INVENTION

In order to accomplish the above objects, according to an aspect of the present invention, there is provided a leakage current interruption device in which it is installed at the power line for supplying the electrical energy to the electrical load and it is cut off the leakage current flowing to the load comprising:

the leakage current interruption device in which it is coupled electrically between the power switch and the load:

first and second input stages coupled with a side of the power source;

first and second output stages coupled with a side of the load;

first and second switching members for turning on and off respectively the electrical connection between the first and second input stages and the first and second output stages;

a switching driving member in which it is coupled between the first and second input stages and generates and outputs a switching driving signal to turn on or off the first and second switching members according to the on or off signals of the power switch.

Preferably, wherein the first and second switching members are relay switches.

More preferably, wherein the first switching member comprises the first triac and the second switching member comprises the second triac.

More preferably, wherein the switching driving member comprises the first and second capacitors coupled in series between the gates of the first and second tiracs.

More preferably, wherein main electrodes of the first and second triacs are respectively coupled to the sides of the first and second input stages, the second resistor is additionally coupled between the first input stage and the gate electrode of the second triac, and the third resistor is additionally coupled between the first input stage and the gate electrode of the second triac.

More preferably, wherein the fourth resistor is additionally coupled in parallel to the first capacitor between the first and second input stages.

More preferably, wherein the second capacitor is additionally coupled in parallel to the second capacitor between the first and second input stages.

More preferably, wherein the first or second input stages are electrically coupled to the line L or the line N of the power line.

More preferably, wherein the first and second input stages are selectively coupled to R, S, and T phases of the power line.

Hereinafter, an embodiment according to the present invention will be described in detail with reference to the accompanying drawings.

Preferred embodiments will be described hereinafter and these embodiments do not limit the scope of claims of the present invention. Also, with reference to certain embodiments thereof, it will be understood by those skilled in the art that various changes in form and details may be made therein without departing from the spirit and scope of the present invention.

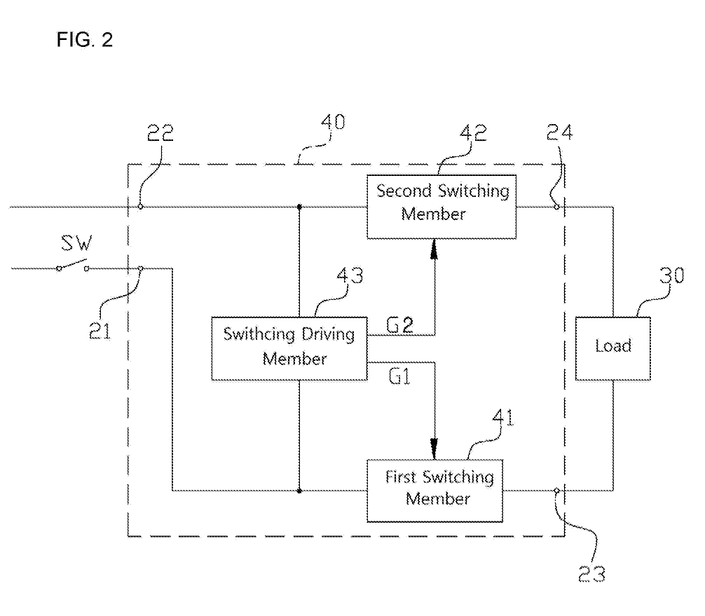

FIG. 2 is a block construction view illustrating the construction of a leakage current interruption device 40 according to an embodiment of the present invention.

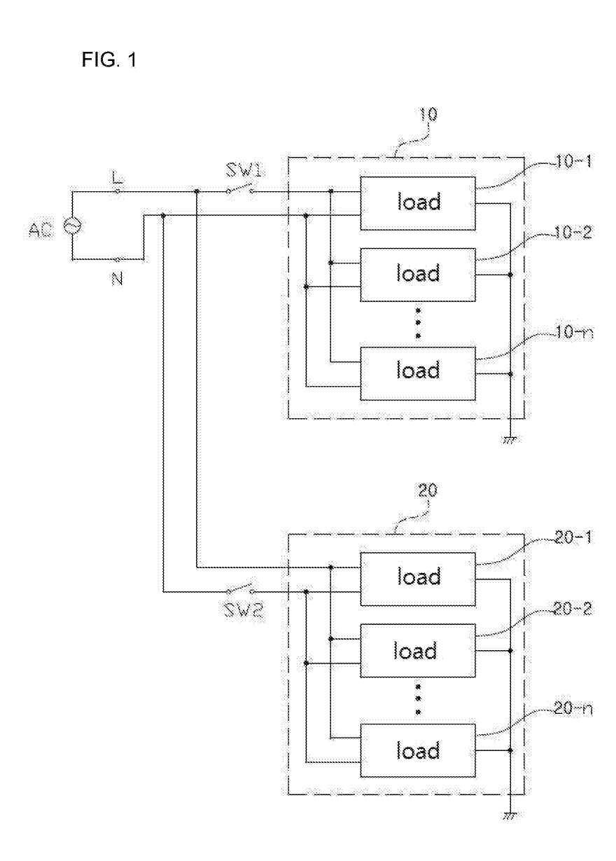

As shown in FIG. 2, the leakage current interruption device 40 is installed between a power switch SW and the load 30. Here, the power switch SW corresponds to the power switch SW1 or SW2 of FIG. 1 and the load 30 corresponds to the load 10 or 20 of FIG. 1.

The leakage current interruption device 40 includes the first and second input stages 21 and 22 coupled to AC(Alternating Current) power side and the first and second output stages 23 and 24 coupled to the load 30. The first and second input stages 21 and 22 are electrically and respectively coupled with the line L and the line N to which power is being supplied or R, S, and T phases of the line L, selectively. And, a power switch SW is selectively installed to the line L or the line N with which the leakage current interruption device 40 is coupled. The leakage current interruption device 40 can be applied to all power distribution types for supplying the phase voltage or line-to-line voltage to the load.

In the leakage current interruption device 40, the first input stage 21 and the first output stage 23 are electrically connected through the first switching member 41, and the second input stage 22 and the second output stage 24 are electrically connected through the second switching member 42. The first and second switching members 41 and 42 are turned on and off by switching driving signals G1 and G2. A switching driving member 43 is coupled between the first and second input stages 21 and 22. The switching driving member 43 detects whether the power switch is on state or off state and then generates the corresponding switching driving signals G1 and G2.

In the above construction, when the power switch SW is set as on state, the switching driving member 43 generates and outputs the driving signals G1 and G2 for setting the first and second switching members 41 and 42 as on state, thereby being set the first and second switching members 41 and 42 by the driving signals G1 and G2 as on state. Accordingly, in this case, the load 30 is electrically coupled to the power side through the power switch SW set as on state, thereby being supplied electrical energy to the load 30.

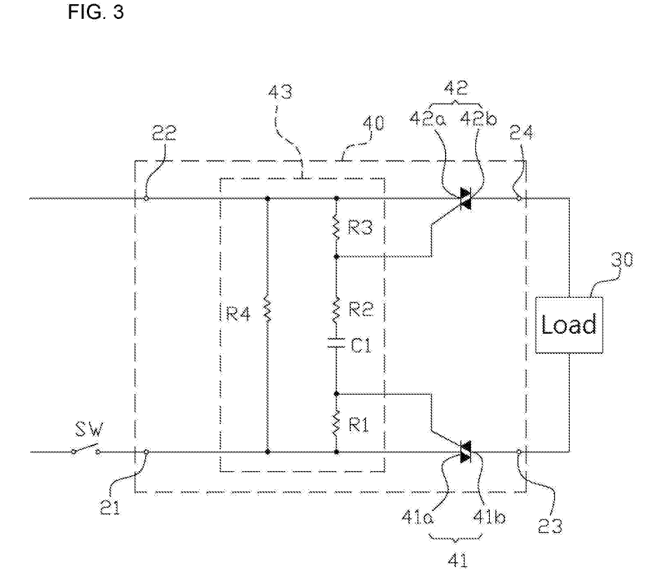

On the other hand, when the power switch SW is set as off state, the switching driving member 43 generates and outputs the driving signals G1 and G2 for setting the first and second switching members 41 and 42 as off state, thereby being set the first and second switching members 41 and 42 by the driving signals G1 and G2 as off state. Accordingly, in this case, the first and second output stages 23 and 24 being coupled with the load 30 are set as the open state to the power side, thereby being cut the all current lines being coupled with the load 30. That is, the whole leakage lines to the load 30 is interrupted, so that the risk by the leakage current is removed completely. FIG. 3 is a circuit construction view illustrating an embodiment of real construction of the leakage current interruption device 40 of FIG. 2.

In this embodiment, triacs are adapted as the first and second switching members 41 and 42. And, the switching driving member 43 is coupled in series between gate electrodes of the first and second triacs 41 and 42, and also consists of including a capacitor C1 and a resistor R2.

In the first and second triacs 41 and 42, main electrodes, that is, the first electrodes 41a and 42a are electrically coupled with the first and second input stages 21 and 22 of the leakage current interruption device 40, and main electrodes, that is, the second electrodes 41b and 42b are electrically coupled with the first and second output stages 23 and 24 of the leakage current interruption device 40. The first and second triacs 41 and 42 are coupled in series with a current path between the first and second input stages 21 and 22 and the first and second output stages 23 and 24, that is, a current path between the power source and the load 30.

When the power switch SW is turned on, AC power source flows through the first electrodes 41a and 42a of the first and second triacs 41 and 42, a gate electrode, a capacitor C1 and a resistor R2, so that the gate current is supplied to the first and second triacs 41 and 42. According this, the first and second triacs 41 and 42 are turned on and then the external power source is supplied to the load 30. Here, the capacitor Cl of the switching driving member 43 causes a short circuit near the zero crossing point of AC power source so that the gate current to the first and second triacs 41 and 42 is flowing smoothly and when it is charged by supplying the power source, the current flow is limited so that the supply of an excessive gate current to the first and second triacs 41 and 42 is prevented.

Also, a resistor R2 is to prevent the excessive gate current from supplying to the first and second triacs 41 and 42 by the short state of the capacitor C1 at the moment that the power switch SW is turned on.

Also, in the switching driving member 43, resistors R1 and R3 are respectively coupled between the first electrodes 41a and 42a and a gate electrode of the first and second triacs 41 and 42. These resistors R1 and R3 is to prevent the leakage current from supplying to the load 30 by turning on the first and second triacs 41 and 42 by the improper external current, that is, a leakage current being supplied through the power line at the off state of the power switch SW.

The voltage between the main electrode and the gate electrode is set as the constant critical voltage, for example, 1V over, the gate current flows between the main electrode and the gate electrode, the triacs 41 and 42 are turned on. When the current is supplied from the outside through the first or second input stages 21 and 22, the corresponding current flows firstly through the resistor R1, the capacitor C1, and resistors R2 and R3 coupled in series between the first and second input stages 21 and 22. At this time, the divided voltage by resistors R1 and R3 is set as the voltage between the main electrode and the gate electrode of the first and second triacs 41 and 42. In a state that the power switch SW is turned off, the resistance of resistors R1 and R3, is set properly so that the first and second triacs 41 and 42 are not turned on by the leakage current which can be supplied from the outside or the standby current of a remote control switch and so on.

Also, a resistor R4 is coupled in parallel to the capacitor C1 between the first and second input stages 21 and 22. The resistor R4 is for discharging power source charged to the capacitor C1.

Hereinafter, the operation of the device with the above-construction will be described.

At first, in the leakage current interruption device 40 according to the present invention, the first and second input stages 21 and 22 are electrically coupled with the line of the power source side and the first and second output stages 23 and 24 are electrically coupled with the load 30. Especially, the leakage current interruption device 40 is coupled between the power switch SW and the load 30.

When the power switch SW is set as on state, the external AC power source flows toward the first direction from the first input stage 21 to the second input stage 22 or the second direction from the second input stage 22 to the first input stage 21, and these current flow processes are repeated alternately.

At the moment that the power switch SW is turned on, if the current of the power source flows from the first input stage 21 to the second input stage 22, that is, the first direction, the power switch SW is turned on and at the same time, the current of the power source flows to the second input stage 22 through sequentially the resistor R1, the capacitor C1, and resistors R2 and R3. By this current flow, when the voltage by resistors R1 and R3 increased the critical voltage of the first and second triacs 41 and 42, that is, 1V over, the gate current is supplied to the first and second triacs 41 and 42 and then the first and second triacs 41 and 42 are turned on. That is, as shown in FIG. 2, driving signals G1 and G2 are outputted at the switching driving member 43 and then the first and second switching members 41 and 42 are turned on. According this, the first and second input stages 21 and 22, the first and second output stages 23 and 24, and the load 30 are electrically coupled with each other and then the external power source is supplied to the load 30 normally.

Also, when the gate current flows through the first and second triacs 41 and 42, the capacitor C1 is charged and the flow of the gate current is limited. Accordingly, as the voltage of AC power source increases, the supply of the excessive gate current to the first and second triacs 41 and 42 is limited.

On the other hand, when the voltage is dropped toward the neighborhood of zero crossing point in order to be changed the current flow of the external power source from the first direction to the second direction, the first and second triacs 41 and 42 are turned off at the moment that the divided voltage by resistors R1 and R3 is dropped under the critical voltage of the first and second triacs 41 and 42.

Subsequently, when the flow of the external power source passes the zero crossing point and then is changed toward the second direction, the power current is inputted to the second input stage 22 and then flows to the first input stage 21 through resistors R3 and R2, the capacitor C1, and the resistor R2. Certainly, at this initial state, the first and second triacs 41 and 42 are maintained as the off state.

When the external power source voltage increased and the divided voltage by resistors R1 and R3 increased to the critical voltage of the first and second triacs 41 and 42 over, the gate current flows to the first and second triacs 41 and 42 and then the first and second triacs 41 and 42 are turned on. And, thereafter, as the above described operations, the external power source is supplied normally. Also, in this case, the capacitor C1 prevents the excessive gate current from flowing to the first and second triacs 41 and 42.

The above operation is repeated whenever the external power source is changed from the first direction and the second direction.

On the other hand, at the above normal operation state, when the power switch SW is turned off, the gate current which has been supplied to the first and second triacs 41 and 42 is cut off and then the first and second triacs 41 and 42 are turned off, so that the load 30 is set perfectly as a separation state to the power source line. That is, in FIG. 2, the power switch SW is set as off state, the driving signals G1 and G2 from the switching driving member 43 are outputted to set the first and second triacs 41 and 42 as off state, so that the first and second triacs 41 and 42 are set as off state.

Thereafter, the first and second triacs 41 and 42 are maintained as off state until the external power switch SW is turned on, so that it is certainly prevented to provide the leakage current and so on to the load 30.

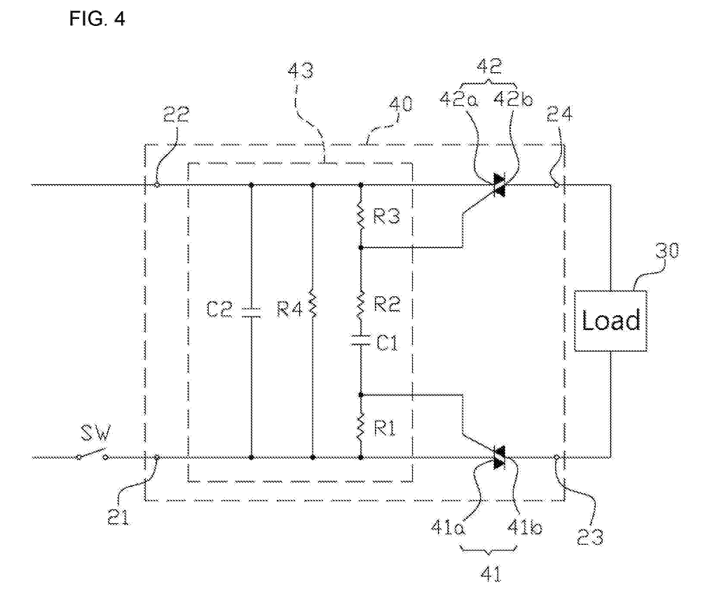

FIG. 4 is a circuit construction view illustrating the construction of the leakage current interruption device 40 according to an embodiment of the present invention. In this embodiment, in the leakage current interruption device of FIG. 3, a capacitor C2 is coupled in parallel to a current path which is formed by a resistor R1, a capacitor C1, and resistors R2 and R3 between the first and second input stages 21 and 22.

As the power switch SW has been used at present, there exist a mechanical switch being driven manually by a user and an electronic switch in which its on and off are driven by using a remote control device and so on. And, in case of the electronic power switch SW, the standby power source is separately required to receive the external operating signal. In general, since the standby power source is generated by using the external power source, in the case that the electronic power switch is adapted, although the power switch SW is set as off state, it needs to provide a power source path for the power switch SW.

In this embodiment, the capacitor C2 is to provide a current path for the standby power source of the power switch SW between the first and second input stages 21 and 22. And, since the remaining parts are substantially the same as the embodiment of FIG. 3, the detailed description to the same parts of FIG. 3 is omitted and the same reference numerals to the same parts of FIG. 3 are also used.

### INDUSTRIAL APPLICABILITY

According to the embodiments of the present invention, when the power switch is set as the off state, the off state is detected and then the load is cut off completely from the power line, thereby preventing the leakage current and so on from flowing through the load completely. Accordingly, fire or the risk of electrical shock generated from the improper current flow such as the leakage current and so on, the unnecessary electric energy consumption, and the flicker phenomenon in the illumination lamp and so on can be removed.

Also, the present invention is not limited to the above embodiments and can be variously modified without departing the technical idea in hereinafter claims of the present invention. For example, in the above embodiments, although triacs are used as the first and second switching members 41 and 42, an arbitrary switching member such as a relay switch and so on can be adapted preferably to turn on and off a current path by using an external driving signal.

Also, it can be understood by an ordinary skilled person that the construction of the switching driving member 43 can be modified to be adapted the construction of the switching members 41 and 42.

1. A leakage current interruption device in which it is installed at the power line for supplying the electrical energy to the electrical load and it is cut off the leakage current flowing to the load comprising:
the leakage current interruption device in which it is coupled electrically between the power switch and the load:
first and second input stages coupled with a side of the power source;
first and second output stages coupled with a side of the load;
first and second switching members for turning on and off respectively the electrical connection between the first and second input stages and the first and second output stages;
a switching driving member in which it is coupled between the first and second input stages and generates and outputs a switching driving signal to turn on or off the first and second switching members according to the on or off signals of the power switch.

2. The leakage current interruption device according to claim 1, wherein the first and second switching members are relay switches.

3. The leakage current interruption device according to claim 1, wherein the first switching member comprises the first triac and the second switching member comprises the second triac.

4. The leakage current interruption device according to claim 3, wherein the switching driving member comprises the first and second capacitors coupled in series between the gates of the first and second tiracs.

5. The leakage current interruption device according to claim 4, wherein main electrodes of the first and second triacs are respectively coupled to the sides of the first and second input stages, the second resistor is additionally coupled between the first input stage and the gate electrode of the second triac, and the third resistor is additionally coupled between the first input stage and the gate electrode of the second triac.

6. The leakage current interruption device according to claim 4, wherein the fourth resistor is additionally coupled in parallel to the first capacitor between the first and second input stages.

7. The leakage current interruption device according to claim 4, wherein the second capacitor is additionally coupled in parallel to the second capacitor between the first and second input stages.

8. The leakage current interruption device according to claim 1, wherein the first or second input stages are electrically coupled to the line L or the line N of the power line.

9. The leakage current interruption device according to claim 1, wherein the first and second input stages are selectively coupled to R, S, and T phases of the power line.
